(19) United States
(12) Patent Application Publication
(10) Pub. No.: US 2009/0056854 A1
(43) Pub. Date: Mar. 5, 2009

(54) METHOD FOR MANUFACTURING CONDUCTIVE COMPOSITE MATERIAL

(75) Inventors: Sang-Keun Oh, Gyeonggi-do (KR); June-Ki Park, Gyeonggi-do (KR)

Correspondence Address: KED & ASSOCIATES, LLP, P.O. Box 221200, Chantilly, VA, 20153-1200, US

(73) Assignee: TOP-NANOSIS, INC., Seongnam-si, Gyeonggi-do (KR)

(21) Appl. No.: 12/295,859

(22) PCT Filed: Apr. 4, 2007
(86) PCT No.: PCT/KR2007/001643

§ 371 Date: Oct. 2, 2008

(30) Foreign Application Priority Data
Apr. 4, 2006 (KR) 10-2006-0030683
Apr. 4, 2006 (KR) 10-2006-0030684
Apr. 4, 2006 (KR) 10-2006-0030685

(51) Int. Cl. B32B 37/02; B05D 5/12

(52) U.S. Cl. 156/60; 427/58

(57) ABSTRACT

A conductive composite material is provided, including: a base layer; a conductive fiber thin-film made of conductive fiber and formed on the base layer; and a mixture layer in which part of the conductive fiber is inserted into part of the base layer.

### TECHNICAL FIELD

The present invention relates to a conductive composite material, which is flexible and used in an electronic product such as a flat panel display, and a method for manufacturing the same.

### BACKGROUND ART

Transparent conductive materials have been widely used in a thin-film transistor liquid crystal display (TFT-LCD), a plasma display panel (PDP), an organic light emitting diode (OLED), a touch panel, an electromagnetic-wave shield, an electrostatic-discharge shield, a heat reflector, a surface heater, a photo-electric converter, etc.

Indium tin oxide (ITO) has been widely used as a transparent conductive material because of its good electrical characteristics and high light transmissivity. However, ITO is brittle such that it is mechanically unstable when folded or bent. Furthermore, ITO tends to be deformed when thermally expanded.

As an electrode material, researches have recently been focused on conductive polymers, such as polyacetylene, polypyrrole, polyaniline, or polythiophen, as substitutes for ITO. A conductive polymer electrode is more flexible and less brittle than the ITO electrode such that it is mechanically stable when bent or folded. However, since the conductive polymer absorbs visible light, an electrode coated with a thick conductive polymer has a very poor light transmissivity. In addition, since most of the conductive polymers are insoluble, their thin-film processes are very complicated and their applicable process temperatures are very low.

A carbon nanotube (CNT) has recently been proposed as a conductive material for a transparent electrode. The carbon nanotube has an excellent electrical conductivity, a good adhesiveness to substrates, and a low deformation due to thermal expansion. The carbon nanotube has metallic or semi-conductive characters depending on winding angles of a graphen sheet and diameters of a tube, has a resistivity as low as 10⁻⁴ to 10⁻³ Ωcm. In addition, the carbon nanotube has excellent mechanical characteristic and chemical stability, and a wide surface area. Furthermore, since a low percolation threshold is formed with a small amount of carbon nanotube, a transparent film is obtained in a visible light range.

FIG. 1 illustrates a conductive composite material 10 which is disclosed in Korean Laid-Open Patent Application No. 2005-115230. The conductive composite material 10 includes a substrate 11 and a transparent conductive layer 12. The substrate 11 is made of a transparent material, such as thermoplastic resin, thermosetting resin, or glass.

The transparent conductive layer 12 is provided on the substrate 11. The transparent conductive layer 12 includes a carbon nanotube 12a and a binding agent 12b. The binding agent 12b acts to bind the substrate 11 with the carbon nanotube 12a. The binding agent 12b is formed on the substrate 11 and is made of material which exhibits good weathering resistance and corrosion resistance together with high surface strength. The binding agent 12b is normally made of a polymer film.

The conductive composite material 10 is prepared by making a coating solution, applying the coating solution on the substrate 11, and drying the coating solution. The coating solution is made by dissolving the binding agent 12b in a volatile solvent and dispersing the carbon nanotube 12a in the volatile solvent.

The conductive composite material 10 thus prepared further includes the binding agent 12b to bind the substrate 11 with the carbon nanotube 12a. That is, since the carbon nanotube 12a is dispersed in the binding agent 12b, a relatively large amount of carbon nanotube 12a is needed to obtain an appropriate surface resistance, causing an increased cost and a reduced transparency.

Furthermore, since the carbon nanotube 12a is formed on the substrate 11 by coating or spray, it is not easy to form patterns on the conductive composite material, such that an additional process is needed to form the patterns.

As shown in FIG. 2, a conductive fiber 22, such as carbon nanotube, is directly formed on the substrate 21 in order to enhance the transparency and conductivity of the conductive composite material. In this case, however, since a binding part binding the substrate 21 with the conductive fiber 22 is thin, and the conductive fiber 22 has a poor dispersion degree and a poor adhesiveness to the substrate 21, the conductive fiber 22 is not securely fixed to the substrate 21. In addition, since the conductive fiber 22 is formed on the substrate 21 by coating or spray, it is not easy to form patterns on the conductive composite material, such that an additional process is needed to form the patterns.

### DISCLOSURE OF INVENTION

### Technical Solution

The present invention provides a conductive composite material, which has stable adhesiveness and high electrical conductivity together with good optical transparency and high transformability, and a method for manufacturing the same.

Additional features of the invention will be set forth in the description which follows, and in part will be apparent from the description, or may be learned by practice of the invention.

### Advantageous Effects

A conductive fiber thin-film is fixed to a base layer by fixing a conductive fiber in a conductive fiber dispersion solution to the base layer and removing the remaining materials through the base layer. Accordingly, the conductive fiber thin-film is reduced in thickness, resulting in enhanced transparency. In addition, the conductive fiber thin-film is formed of the conductive fiber, resulting in enhanced conductivity.

In addition, since part of the conductive fiber thin-film is dispersed and inserted into part of the base layer, it is not necessary to have an additional element to fix the conductive fiber thin-film to the base layer, resulting in stable adhesiveness and high conductivity.

Furthermore, the conductive fiber in the conductive fiber dispersion solution is fixed to an initial base layer, the remaining materials are removed through the initial base layer, and the conductive fiber thin-film is moved to a final base layer. Accordingly, the conductive fiber thin-film is reduced in thickness, resulting in high conductivity and enhanced dispersion degree.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional view of a conventional conductive composite material.

FIG. 2 is a cross-sectional view of another conventional conductive composite material.

FIG. 3 is a cross-sectional view of a conductive composite material according to an exemplary embodiment of the present invention.

FIG. 4 is an enlarged cross-sectional view of the ‘A’ part of FIG. 3.

FIG. 5 is a flow chart of a method for manufacturing a conductive composite material according to an exemplary embodiment of the present invention.

FIG. 6 is a flow diagram of a method for manufacturing a conductive composite material according to an exemplary embodiment of the present invention.

FIG. 7 illustrates a process of providing a conductive fiber thin-film on a membrane.

FIG. 8 illustrates processes of fixing a conductive fiber thin-film to a membrane and making the membrane transparent.

FIG. 9 is an enlarged cross-sectional view of the ‘B’ part of FIG. 6.

FIG. 10 is an enlarged cross-sectional view of the ‘C’ part of FIG. 9.

FIG. 11 is a flow chart of a method for manufacturing a conductive composite material according to another exemplary embodiment of the invention.

FIG. 12 is a cross-sectional view of an initial base layer of FIG. 11.

FIG. 13 illustrates a process of providing a conductive fiber thin-film on an initial base layer of FIG. 11.

FIGS. 14 and 15 illustrate a process of moving a conductive fiber thin-film of FIG. 11 to a final base layer.

FIG. 16 illustrates a process of securely fixing a conductive fiber thin-film to a final base layer.

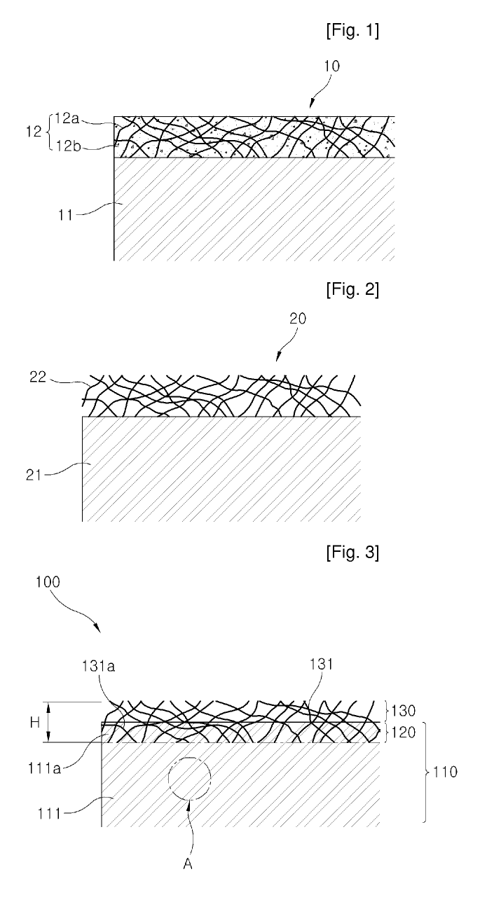

### BEST MODE FOR CARRYING OUT THE INVENTION

The present invention discloses a conductive composite material including: a base layer; a conductive fiber thin-film made of conductive fiber and formed on the base layer; and a mixture layer in which part of the conductive fiber is inserted into part of the base layer.

The present invention also discloses a method for manufacturing a conductive composite material, including: providing a membrane; forming a carbon nano-fiber film on the membrane by removing through pores of the membrane at least part of materials except carbon nano-fiber from a carbon nano-fiber dispersion solution; fixing the carbon nano-fiber film to the membrane; and making the membrane transparent.

The present invention also discloses a method for manufacturing a conductive composite material, including: providing an initial base layer; providing a conductive fiber thin-film on the initial base layer; and moving the conductive fiber thin-film provided on the initial base layer to a final base layer.

It is to be understood that both the foregoing general description and the following detailed description are exemplary and explanatory and are intended to provide further explanation of the invention as claimed.

### Mode for the Invention

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

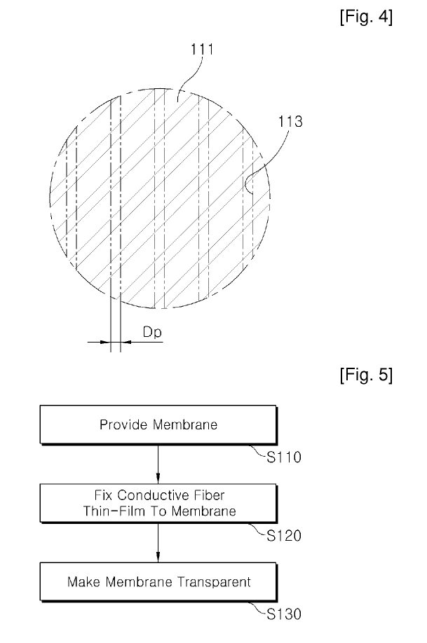

FIG. 3 is a cross-sectional view of a conductive composite material according to an exemplary embodiment of the present invention. FIG. 4 is an enlarged cross-sectional view of the ‘A’ part of FIG. 3.

A conductive composite material 100 includes a base layer 110, a conductive fiber thin-film 130, and a mixture layer 120.

The conductive fiber thin-film 130 is provided on the base layer 110, and the mixture layer 120 is provided between the base layer 110 and the conductive fiber thin-film 130 to securely fix the base layer 110 and the conductive fiber thin-film 130 to each other.

The base layer 110 may be made of a polymer 111 which is preferably flexible. Examples of the polymer 111 include polycarbonate, polyethylene terephtalate (PET), polyamide, cellulose ester, regenerated cellulose, nylon, polypropylene, polyacrylonitrile, polysulfone, polyethersulfone, and polyvinylidenfluoride.

As shown in FIG. 4, the polymer 111 may be made of a polymer membrane having pores 113 each having a diameter Dp. In a process of forming the conductive fiber thin-film 130, all or most of materials, such as a binding agent, except a conductive fiber, may be removed, whereby the conductive fiber thin-film 130 is made only of the conductive fiber.

In this case, the polymer 111 made of the polymer membrane may be made of a material in which the pores 113 are removed when more than a predetermined level of heat and/or pressure is applied to the polymer 111. The polymer 111 may be made of a material in which the pores 113 are removed when more than a predetermined intensity of light is irradiated on the polymer 111. The polymer 111 may be made of a material in which the pores 113 are removed when more than a predetermined level of voltage is applied to the polymer 111. The polymer 111 is not transparent due to the presence of the pores 113. That is, when the pores 113 are removed, the polymer 111 is made transparent. Therefore, when a conductive composite material 100 needs to have an excellent light transmissivity, a transparent polymer is obtained by applying a pre-determined condition, such as heat, pressure, light or voltage, to remove the pores 113.

In this case, the polymer membrane may be changed to be optically transparent at a glass transition temperature Tg, and have a thickness of 10 to 1000 mm.

The polymer membrane preferably has pores each having a diameter Dp of 0.01 to 10 mm. When the diameter Dp is larger than 10 mm, the conductive fiber is removed through the pores. When the diameter Dp is smaller than 0.01 mm, the permeability of solution is very low.

The polymer membrane may be optically transparent by coating a soluble organic solvent. Examples of the soluble organic solvent include benzene, toluene, xylene, chloroform, methylen chloride, acetone, methyl ethyl ketone, cyclohexanone, ethyl acetate, dioxane, tetrahydrofuran, dimethyl formamide, and dimethylsulfoxide.

The conductive fiber thin-film 130 is provided on the base layer 110. The conductive fiber thin-film 130 is made of conductive fibers 131. The conductive fibers 131 may be separated from one another, while at least part of the conductive fibers 131 may be contiguous to one another.

The conductive fiber 131 may be a carbon fiber or, preferably, a carbon nanotube. The carbon nanotube is structured in such a manner that a graphene sheet is tubularly wound which is honeycombed with a carbon atom bound with three other carbon atoms. The carbon nanotube has a diameter of 1 to 100 nm. The carbon nanotube is divided into a single-walled carbon nanotube and a multi-walled carbon nanotube according to the number of graphene sheets which form walls of the carbon nanotube. The single-walled carbon nanotube is formed in a bundle of tubes.

The carbon nanotube has an excellent conductivity since it has a resistivity as low as 10⁻⁴ to 10⁻³ Ωcm. The carbon nanotube has excellent mechanical characteristics, is chemically stable and has a large surface area. Since the carbon nanotube shaped like a bar has a large aspect ratio, it is easy to form a low percolation threshold such that its conductivity is excellent.

A method for manufacturing the conductive fiber thin-film 130 from the carbon nanotube as the conductive fiber will be described.

First, carbon nanotube aqueous dispersion solution or carbon nanotube organic dispersion solution is prepared. The carbon nanotube aqueous dispersion solution is prepared by adding carbon nanotube to an aqueous solution in which a surface active agent, such as Triton X-100, sodium dodecylbenzene sulfonate (Na-DDBS), cetyl trimethyl ammonium bromide (CTAB) or sodium dodecyl sulfate (SDS), is dissolved, and applying ultrasonic waves to the solution for 1 to 120 minutes. The carbon nanotube organic dispersion solution is prepared by adding carbon nanotube to an organic solution, such as N-methylpyrrolidone (NMP), o-dichlorobenzene, dichloroethane, dimethyl formamide (DMF) or chloroform, and applying ultrasonic waves to the solution for 1 to 120 minutes. However, the carbon nanotube aqueous dispersion solution or carbon nanotube organic dispersion solution may be prepared by other methods.

When the carbon nanotube aqueous dispersion solution or carbon nanotube organic dispersion solution thus prepared is filtered by a large-sized vacuum filter equipped with the base layer 110, at lease part of or, preferably, all of materials, except the carbon nanotube, are removed through the pores 113 of the polymer membrane, such that a uniform carbon nanotube film is formed on the base layer 110.

The thickness of the carbon nanotube film thus formed, i.e., the thickness H of the sum of the mixture layer 120 and the conductive fiber thin-film 130 in FIG. 3, can be easily controlled by adjusting the amount of the carbon nanotube dispersion solution to be filtered. When the carbon nanotube aqueous dispersion solution is used, the carbon nanotube film formed on the polymer membrane can be additionally cleaned using water to remove the surface active agent remaining on the carbon nanotube film after filtering the carbon nanotube aqueous dispersion solution. In this case, the carbon nanotube film preferably has a thickness of 1 to 500 nm. When the thickness H is smaller than 1 nm, it is not possible to obtain a satisfactory conductivity. When the thickness is larger than 50 nm, the light transmissivity of the electrode may decrease.

Since the conductive fiber 131, such as carbon nanotube, is formed of a nano-sized film on the base layer, it is possible to manufacture a transparent electrode with a good conductivity using a small amount of the conductive fiber, compared to the existing conductive composite material in which the carbon nanotube exists inside the polymer membrane.

At least part of materials except the conductive fiber 131 is removed through the polymer membrane while the conductive fiber 131 is uniformly dispersed in the solvent, such that the conductive fiber 131 is uniformly dispersed on the polymer 111. In addition, when the whole or most of the conductive fiber thin-film 130 is made only of the conductive fiber 131, the conductive composite material 100 has an excellent conductivity. Furthermore, since the conductive fiber thin-film 130 has a reduced thickness and has more than a predetermined conductivity, the conductive composite material 100 has an excellent transparency.

The mixture layer 120 is provided between the base layer 110 and the conductive fiber thin-film 130. The mixture layer 120 is formed by inserting part 131a of the conductive fiber 131 into part 11a of the base layer 110. The mixture layer 120 may be formed by pressing the base layer 110 and the conductive fiber thin-film 130. Prior to pressing, the base layer 110 is subjected to heat treatment so that the conductive fiber of the conductive fiber thin-film 130 can be satisfactorily dispersed in the base layer 110 upon pressing.

The mixture layer 120 is formed by inserting the part 131a of the conductive fiber into the base layer 110. The density of the conductive fiber 131 per the unit volume of the mixture layer 120 is less than the density of the conductive fiber 131 per the unit volume of the conductive fiber thin-film 130. Therefore, the conductive fiber thin-film 130 has an excellent conductivity. In the present embodiment of the invention, the conductive fiber thin-film 130 may have a resistivity of 10 to 10⁸ Ω/sq.

The mixture layer 120 may be formed by inserting part of the conductive fiber 131 of the conductive fiber thin-film 130 into at least part of the pores 113 of the polymer membrane which is provided in the base layer 110. That is, the conductive fiber and the polymer membrane are more securely bound with each other by directly binding the conductive fiber thin-film 130 with the base layer 110.

The conductive fiber and the polymer membrane are physicochemically bound with each other due to interdigitation on an interface therebetween, such that the conductive fiber thin-film is bounded much more securely. According to the present embodiment of the invention, it is possible to save the amount of conductive fiber, and to prevent the conductivity from decreasing when the conductive fiber, particularly carbon nanotube, is dispersed in the polymer. Therefore, it is possible to obtain an excellent conductivity without the need to coat an additional conductive polymer film.

According to a conventional method for coating a carbon nanotube dispersion solution on a transparent polymer film, a carbon nanotube film is not uniform and is not securely fixed, such that it is very difficult or not possible to manufacture a conductive composite film which is large and uniform. However, according to the present embodiment of the invention, it is possible to very securely fix a conductive fiber thin-film to a polymer by positioning a uniform conductive fiber (carbon nanotube) thin-film on a non-transparent polymer (polymer film), and fixing the conductive fiber thin-film to the polymer simultaneously with or following making the polymer transparent by heat, pressure, or solvent-coating. In addition, since the conductive fiber such as carbon nanotube is provided on the transparent polymer, it is possible to manufacture a soft and transparent conductive composite material 100 having an excellent conductivity using an extremely small amount of conductive fiber, compared to the conventional composite film in which the carbon nanotube is uniformly dispersed in the polymer matrix.

The transparent conductive composite material 100 may be used in a thin-film transistor liquid crystal display (TFT-LCD), a plasma display panel (PDP), an organic light emitting diode (OLED), a touch panel, an electromagnetic-wave shield, an electrostatic-discharge shield, a heat reflector, a surface heater, a photo-electric converter, etc. In particular, the transparent conductive composite material 100 is flexible, light and mechanically stable, such that it may be used as a transparent electrode of a large-sized flexible display.

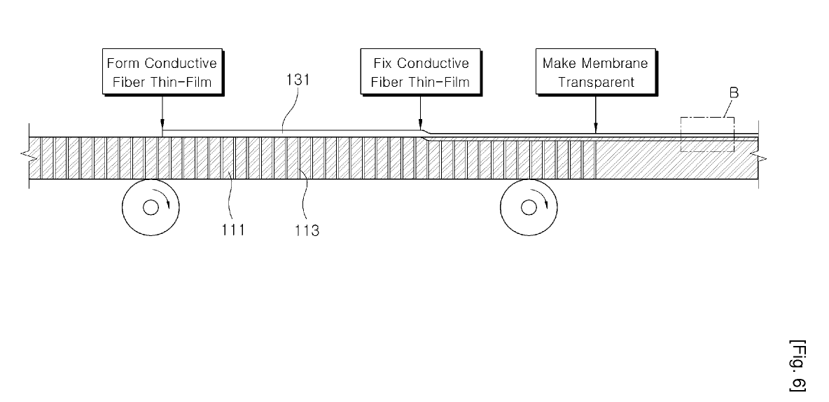

FIG. 5 is a flow chart of a method for manufacturing a conductive composite material according to an exemplary embodiment of the present invention.

The method according to the present embodiment of the invention includes providing a membrane (S110), and fixing a conductive fiber thin-film to the membrane (S120). The method may further include making the membrane transparent (S130).

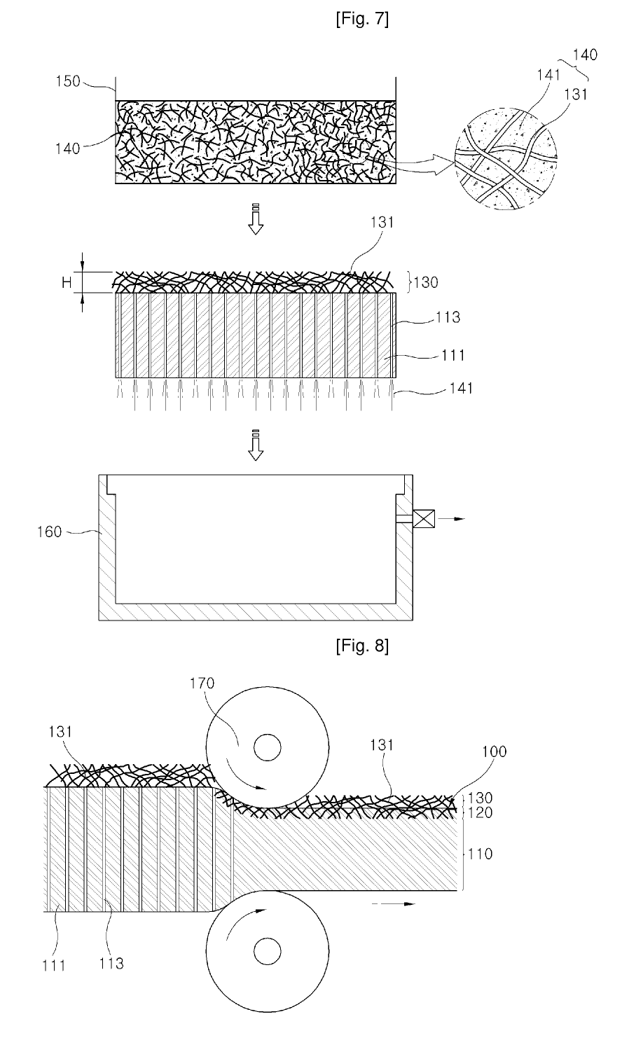

FIG. 6 is a flow diagram of a method for manufacturing a conductive composite material according to an exemplary embodiment of the present invention. FIGS. 7 to 9 illustrate individual processes shown in FIG. 6.

First, a membrane is provided. The membrane is made of the polymer 111 and has a plurality of pores 113 as shown in FIG. 4. The membrane acts so that all or most of materials, such as a solvent normally including dispersion agent and binding agent, except the conductive fiber can be removed through the pores 113 of the membrane while the conductive fiber thin-film is formed.

Examples of the polymer membrane include polycarbonate, polyethylene terephtalate (PET), polyamides, cellulose ester, regenerated cellulose, nylon, polypropylene, polyacrylonitrile, polysulfone, polyethersulfone, and polyvinylidenfluoride. In this case, the membrane may be a polymer membrane with pores each having a diameter Dp of 0.01 to 10 mm and a thickness of 10 to 1000 mm.

Subsequently, as shown in FIG. 7, the conductive fiber thin-film 130 is fixed to the membrane. The conductive fiber thin-film 130 is made only or mostly of a conductive fiber formed in a thin-film layer.

The conductive fiber 131 may be carbon fiber. Examples of the carbon fiber include a single-walled carbon nanotube, a double-walled carbon nanotube, a multi-walled carbon nanotube, a carbon nano-fiber, and graphite.

The conductive fiber 131 may preferably be a carbon nanotube. The carbon nanotube is structured in such a manner that a graphene sheet is tubularly wound which is honeycombed with a carbon atom bound with three other carbon atoms. The carbon nanotube has a diameter of 1 to 100 nm. The carbon nanotube is divided into a single-walled carbon nanotube and a multi-walled carbon nanotube according to the number of graphene sheets which form walls of the carbon nanotube. The single-walled carbon nanotube is formed in a bundle of tubes.

The carbon nanotube has an excellent conductivity since it has a resistivity as low as 10⁻⁴ to 10⁻³ Ωcm. The carbon nanotube has excellent mechanical characteristics, is chemically stable and has a large surface area. Since the carbon nanotube shaped like a bar has a large aspect ratio, it is easy to form a low percolation threshold such that an excellent conductivity is obtained.

In this case, the carbon nanotube film preferably has a thickness H of 1 to 500 nm. When the thickness is smaller than 1 nm, it is not possible to obtain a satisfactory conductivity. When the thickness is larger than 500 nm, the light transmissivity of the electrode may decrease.

The step of fixing the conductive fiber thin-film 131 to the membrane may include placing a conductive fiber dispersion solution 140 on the membrane, and removing at least part of materials except the conductive fiber 131 from the conductive fiber dispersion solution 140 through the pores 113 of the membrane.

During the above-mentioned process, at least part of the materials 141, such as a solvent normally including a binding agent and a dispersion agent, except the conductive fiber 131 is removed through the membrane from the solvent in which the conductive fiber 131 is dispersed, whereby the conductive fiber thin-film 130 can be uniformly dispersed on the membrane. Furthermore, since the whole or most of the conductive fiber thin-film 130 is made only of the conductive fiber 131, its conductivity is enhanced. Accordingly, the thickness of the conductive fiber thin-film 130 can be reduced, such that the conductive composite material has an enhanced transparency. In addition, the solvent can be removed when the conductive fiber 131 is uniformly dispersed in the solvent, whereby the conductive fiber 131 has an excellent dispersion degree on the membrane, and has a more improved conductivity.

The conductive fiber dispersion solution may be formed on the membrane by vacuum filtering, self-assembly technique, Langmuir-Blodgett technique, solution casting, bar coating, dip coating, spin coating, jet coating, etc.

The conductive fiber thin-film 130 may be uniformly dispersed on the membrane by vacuum filtering. For example, as shown in FIG. 7, the conductive fiber aqueous dispersion solution 140 is prepared by adding the conductive fiber 131 to the solvent 141 in which a surface active agent is dissolved. Examples of the surface active agent include Triton X-100, sodium dodecylbenzene sulfonate (Na-DDBS), cetyl trimethyl ammonium bromide (CTAB) and sodium dodecyl sulfate (SDS). For another example, the conductive fiber aqueous dispersion solution is prepared by adding the conductive fiber to the aqueous solution and applying ultrasonic waves to the solution, for example, for 1 to 120 minutes.

The conductive fiber aqueous dispersion solution 140 may be prepared by other methods. For example, the conductive fiber aqueous dispersion solution 140 may be prepared by adding the conductive fiber 131 to an organic solvent, such as N-methylpyrrolidone (NMP), o-dichlorobenzene, dichloroethane, dimethylformamide (DMF), and chloroform.

Subsequently, the conductive fiber aqueous dispersion solution 140 stored in a solution container 150 is filtered through a vacuum filter 160. The membrane is provided facing the solution container 150 of the vacuum filter 160. The solvent 141 except the conductive fiber 131 is filtered through the pores 113 of the membrane, such that the conductive fiber thin-film 130 is uniformly formed on the membrane. Subsequently, the carbon nanotube film 130 thus formed is cleaned with water.

Through the above-mentioned process, at least part of the conductive fiber 131 can be inserted into part of the membrane. For example, the conductive fiber 131 may be inserted into the pores 113 of the membrane.

As shown in FIG. 8, the method according to the present embodiment of the invention may further include inserting at least part of the conductive fiber thin-film 130 into at least part of the membrane to securely fix the conductive fiber thin-film 130 to the membrane. The conductive composite material 100 may include the base layer 110 formed only of the membrane, the mixture layer 120 having the membrane mixed with the conductive fiber, and the conductive fiber thin-film 130 formed only of the conductive fiber. For an example of the above-mentioned process, as shown in FIG. 8, a predetermined level of heat is applied to the membrane, and the membrane and the conductive fiber thin-film 130 are pressed by a pressing unit 170, such as a roller. That is, the polymer membrane is softened at a predetermined high temperature, and the membrane and the conductive fiber thin-film 130 are pressed with the pressing unit 170, such that part of the conductive fiber 131 is inserted into part of the membrane. Next, after cooling down the conductive composite fiber during a predetermined time, the membrane with part of the conductive fiber 131 inserted is hardened. Accordingly, the conductive fiber thin-film 130 is securely fixed to the membrane.

However, since the membrane has the pores 113 therein, the conductive composite material may neither be transparent nor have a satisfactory transparency. Accordingly, the method according to the present embodiment of the invention may further include making the membrane transparent.

The membrane may be made transparent by removing the pores 113. The membrane may be made of a material in which the pores 113 are removed upon applying more than a predetermined level of heat and/or pressure to the membrane, a material in which the pores 113 are removed upon irradiating more than a pre-determined intensity of light on the membrane, or a material in which the pores 113 are removed upon applying more than a predetermined level of voltage to the membrane. For example, when the membrane is made of a material which changes to be optically transparent at a glass transition temperature Tg, the pores 113 of the membrane are removed by applying heat to the membrane at more than the glass transition temperature Tg.

The membrane may be changed to be optically transparent by coating a soluble organic solvent on the membrane. Examples of the soluble organic solvent include benzene, toluene, xylene, chloroform, methylen chloride, acetone, methyl ethyl ketone, cyclohexane, etyle acetate, dioxane, tetrahydrofuran, dimethylformamide, and dimethylsulfoxide.

The membrane having the conductive fiber thin-film 130 formed thereon may be made transparent either in a consecutive manner using a hot-pressing roller which has preheating, heating and cooling roller units, or in a discontinuous manner using a plane-pressing unit.

In the above-mentioned process of preparing the transparent conductive composite material, all equipment contacting with the surface of the membrane are hard-faced so that the heated membrane cannot stick to the equipment. In particular, the heating roller unit of the hot-pressing roller preferably has a surface with an average roughness less than 0.2a, and is made of stainless steel (SUS) which will not stick to the heated polymer.

Before, after or during making transparent the membrane having the conductive fiber formed thereon, an optically transparent plastic film may be formed on an upper surface of the conductive fiber thin-film and/or a lower surface of the membrane.

As shown in FIG. 8, the step of making the membrane transparent may be carried out simultaneously with the step of securely fixing the conductive fiber thin-film to the membrane. That is, when part of the conductive fiber 131 is inserted into the membrane, a high-temperature heat may be applied to the membrane so that the pores 113 of the membrane can be removed.

According to the present embodiment of the invention, the membrane made of polymer is made transparent when the membrane holds the conductive fiber thin-film, such as carbon nanotube. Accordingly, interdigitation occurs in an interface between the membrane and the conductive fiber thin-film, whereby the carbon nanotube film is securely fixed to the membrane. Therefore, it is possible to substantially reduce an amount of conductive fiber, such as carbon nanotube, and to securely fix the conductive fiber thin-film to the membrane. In addition, since the conductivity is not lowered even though the carbon nanotube is dispersed in the polymer, it is possible to obtain a conductive composite material having an excellent conductivity without coating an additional conductive polymer film.

According to the conventional method for coating a carbon nanotube dispersion solution on a transparent polymer film, it is difficult or not possible to manufacture a large-sized, uniform conductive composite film since a carbon nanotube film is not uniformly formed and is securely fixed. However, according to the present embodiment of the invention, a uniform conductive fiber thin-film is formed on a non-transparent membrane, and the membrane is made transparent and is fixed to the conductive fiber thin-film by heating, pressing, or solvent-coating, whereby it is possible to very securely fix the conductive fiber thin-film to the membrane. In addition, since the conductive fiber is formed only on the surface of the transparent membrane, it is possible to prepare a soft, transparent conductive composite material having an excellent conductivity using a small amount of conductive fiber, compared to the conventional composite film in which a carbon nanotube is uniformly dispersed in a polymer material.

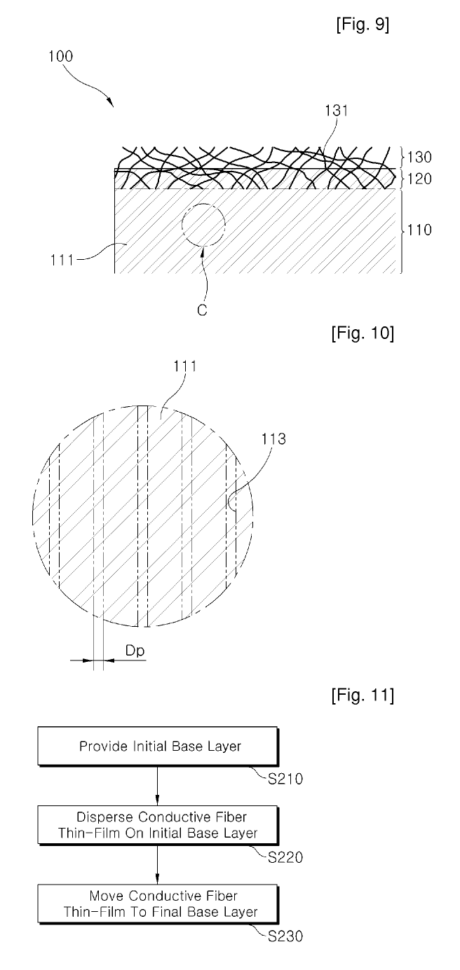

FIG. 9 illustrates the conductive composite material 100 which is prepared by the above-mentioned method. FIG. 10 illustrates an enlarged cross-sectional view of the ‘C’ part of FIG. 9.

The mixture layer 120 is provided between the base layer 110 and the conductive fiber thin-film 130. The mixture layer 120 is formed by inserting part of the conductive fiber 131 of the conductive fiber thin-film 130 into at least part of the pores 113 of the membrane. Accordingly, it is possible to very securely fix the conductive fiber thin-film 130 to the base layer 110.

In addition, since the part 131a of the conductive fiber 131 is inserted into the base layer 110 to form the mixture layer 120, the density of the conductive fiber 131 per the unit volume of the mixture layer 120 is less than the density of the conductive fiber 131 per the unit volume of the conductive fiber thin-film 130. Therefore, the conductive composite material has an excellent conductivity. In the present embodiment of the invention, the conductive composite material may have a resistivity of 10 to 10⁸ Ω/sq.

### EMBODIMENT 1

A carbon nanotube was used as the conductive fiber 130, and a polyethersulfone membrane with pores 113 each having a diameter of 0.2 mm was used.

The conductive fiber thin-film 130 was fixed to the membrane using the vacuum filter shown in FIG. 6. Referring to FIG. 6, 0.0015 wt % carbon nanotube aqueous dispersion solution 140 was prepared by adding 15 mg of a single-walled carbon nanotube 131 (mfg. by ILJIN Nanotech) to 11 of aqueous solution 141 in which 10 g of SDS as a surface active agent was dissolved, and applying 40 kHz ultrasonic waves of 45 W for 30 minutes.

Next, 80 ml of the carbon nanotube aqueous dispersion solution 140 from the container 150 was filtered by the large-sized vacuum filter 160 with a filtering area of 500 cm².

In this case, the base layer 110 made of a polyethersulfone membrane with pores each having a diameter of 0.2 mm is provided in the large-sized vacuum filter 160. A solvent except the carbon nanotube was filtered through the pores 113, such that a carbon nanotube film was uniformly formed on the polymer membrane. Next, the carbon nanotube film thus formed was cleaned with water.

Subsequently, as shown in FIG. 8, the polymer membrane was made transparent using the hot-pressing roller, such that a transparent conductive composite material 100 was obtained in which the carbon nanotube film 130 is formed on the transparent base layer 110. In more detail, the conductive fiber 130 and the membrane was preheated to a temperature of 110° C. using a preheating roller, and the polymer membrane was made transparent through a heating roller with a temperature of 220° C. In this case, at least part of the carbon nanotube forming the conductive fiber thin-film 130 is inserted into the membrane to form the mixture layer 120. Subsequently, it passed through a cooling roller to prevent wrinkles of the polymer membrane and improve the optical characteristic of the transparent polymer membrane.

About 2.4 mg/cm² of the carbon nanotube was obtained per the unit area of the transparent carbon nanotube film.

The light transmissivity of the transparent electrode thus manufactured was measured to be about 90% at 550 nm by an ultraviolet-visible spectroscope. The surface resistance of the transparent electrode was measured to be less than 200 Ω/sq by a surface resistance meter. The uniformity of surface resistance, i.e., the standard-deviation/average of surface resistance, was less than 7%.

The adhesion stability of the carbon nanotube film was estimated at 5B (indicating that there is no carbon nanotube to be removed) by the tape test (ASTM D 3359-02).

As described above, the transparent electrode manufactured according to the present embodiment of the invention was proved to be excellent in transparency, conductivity, uniformity of conductivity, flexibility, and adhesion stability of the carbon nanotube film.

### EMBODIMENT 2

The transparent conductive composite material 100 was prepared in the same method as that of Embodiment 1, except that a carbon nanotube/membrane composite material with a small amount of dimethylformamide (DMF) coated passed through a heating roller with a temperature of 80° C. to make the membrane film transparent.

The transparency, conductivity, uniformity of conductivity, and adhesion stability of the transparent film thus manufactured were examined in the same method as that of Embodiment 1. As a result, the transparent film was proved to have excellent transparency, conductivity, uniformity of conductivity, and adhesion stability, similarly to that of Embodiment 1.

### EMBODIMENT 3

The transparent conductive composite material 100 was prepared in the same manner as that of Embodiment 1, except that during the process of making transplant the membrane having the carbon nanotube film formed thereon, an optically transparent polyethylene terephtalate film was stacked on a lower surface of a polymer film, and a carbon nanotube/membrane composite material with a small amount of dimethylformamide (DMF) coated passed through a heating roller with a temperature of 80° C. to make the membrane film transparent.

The transparency, conductivity, uniformity of conductivity, and adhesion stability of the conductive composite material thus manufactured were examined in the same method as that of Embodiment 1. As a result, the transparent film was proved to have excellent transparency, conductivity, uniformity of conductivity, and adhesion stability, similarly to that of Embodiment 1.

### EMBODIMENT 4

The transparent conductive composite material 100 was prepared in the same method as that of Embodiment 1, except that the carbon nanotube/membrane composite material was made transparent using a plane-pressing unit rather than a hot-pressing roller.

The transparency, conductivity, uniformity of conductivity, and adhesion stability of the conductive composite material thus manufactured were examined in the same method as that of Embodiment 1. As a result, the transparent film was proved to have excellent transparency, conductivity, uniformity of conductivity, and adhesion stability, similarly to that of Embodiment 1.

FIG. 11 is a flow chart of a method for manufacturing a conductive composite material according to another exemplary embodiment of the invention.

The method according to the present embodiment of the invention includes providing an initial base layer (S210), placing a conductive fiber thin-film on the initial base layer (S220), and moving the conductive fiber thin-film onto a final base layer (S230).

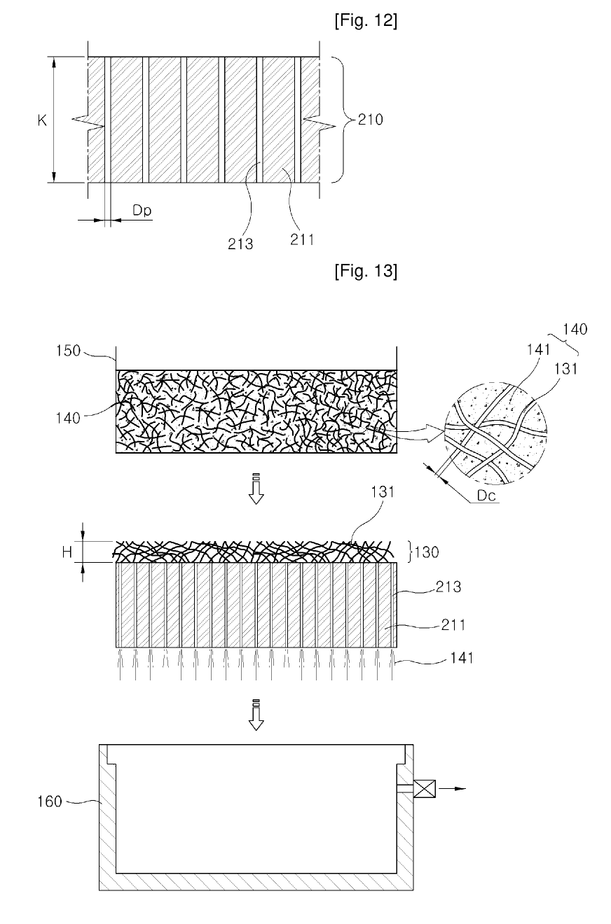

FIGS. 12 to 16 are views for explaining a method for manufacturing a conductive composite material according to an exemplary embodiment of the present invention.

As shown in FIG. 12, an initial base layer 210 is provided. The initial base layer 210 may be formed of a polymer membrane 211 having a plurality of pores 213. The membrane is provided such that all or most of materials except a conductive fiber are removed through the pores 213 of the membrane during the process of manufacturing the conductive fiber thin-film.

The polymer membrane 211 may be made of polycarbonate, polyethylene terephtalate (PET), polyamides, cellulose ester, regenerated cellulose, nylon, polypropylene, polyacrylonitrile, polysulfone, polyethersulfone, or polyvinylidenfluoride. In particular, polyethersulfone exhibits a more improved filtering performance of conductive fiber such that it is easy to separate the conductive fiber thin-film.

In this case, the polymer membrane may have pores each having a diameter Dp of 0.01 to 10 mm, and a thickness K of 10 to 1000 mm.

Subsequently, as shown in FIG. 13, the conductive fiber thin-film 130 is placed on the initial base layer 210. The conductive fiber thin-film 130 is made only or mostly of the conductive fiber 131. In this case, the conductive fiber thin-film 130 may be formed and dispersed on the initial base layer 210, or may be formed on the initial base layer 210.

The conductive fiber 131 may be a carbon fiber. Examples of the carbon fiber include a single-walled carbon nanotube, a double-walled carbon nanotube, a multi-walled carbon nanotube, a carbon nano-fiber, and graphite.

The conductive fiber 131 may preferably be a carbon nanotube. The carbon nanotube is structured in such a manner that a graphene sheet is tubularly wound which is honeycombed with a carbon atom bound with three other carbon atoms. The carbon nanotube has a diameter Dc of 1 to 100 nm. The carbon nanotube is divided into a single-walled carbon nanotube and a multi-walled carbon nanotube according to the number of graphene sheets which form walls of the carbon nanotube. The single-walled carbon nanotube is formed in a bundle of tubes.

The carbon nanotube has an excellent conductivity since it has a resistivity as low as 10⁻⁴ to 10⁻³ Ωcm. The carbon nanotube has excellent mechanical characteristics, is chemically stable and has a large surface area. Since the carbon nanotube shaped like a bar has a large aspect ratio, it is easy to form a low percolation threshold such that its conductivity is excellent.

In this case, the carbon nanotube preferably has a thickness H of 1 to 500 nm. The carbon nanotube with a thickness smaller than 1 nm does not exhibit a satisfactory conductivity. The carbon nanotube with a thickness larger than 500 nm may show a reduced light transmissivity of the electrode.

The step of placing the conductive fiber thin-film 130 on the initial base layer 210 may include placing the conductive fiber dispersion solution 140 on the initial base layer 210, and removing at least part of materials except the conductive fiber 131 from the conductive fiber dispersion solution 140. The conductive fiber dispersion solution 140 may be placed on the initial base layer 210 by vacuum filtering, self-assembly technique, Langmuir-Blodgett technique, solution casting, bar coating, dip coating, spin coating, spray coating, etc.

When the initial base layer 210 is made of a membrane material, the step of placing the conductive fiber thin-film 130 on the initial base layer 210 may include placing the conductive fiber dispersion solution 140 on the membrane, and removing at least part of materials except the conductive fiber 131 from the conductive fiber dispersion solution 140 through the pores 213 of the membrane.

When the conductive fiber 131 is dispersed in the solvent in the above-mentioned process, the conductive fiber thin-film 130 can be uniformly dispersed on the initial base layer 210 by removing through the membrane at least part of the materials 141, such as solvent normally including a dispersion agent or a binding agent, except the conductive fiber 131. Furthermore, since the whole or most of the conductive fiber thin-film 130 is made only of the conductive fiber 131, the conductive fiber thin-film 130 has an excellent conductivity even though the conductive fiber thin-film 130 is reduced in thickness. As a result, the conductive fiber thin-film 130 has an excellent transparency. In addition, when at least part of or, preferably, the whole of the materials 141 except the conductive fiber 131 is removed, the conductive fiber 131 can be uniformly dispersed on the initial base layer 210 and thus have an excellent conductivity.

The conductive fiber thin-film 130 is uniformly dispersed on the initial base layer 210 by vacuum filtering. For example, as shown in FIG. 13, the conductive fiber aqueous dispersion solution 140 is prepared by adding the conductive fiber 131 to the solvent 141 in which the surface active agent is dissolved. Examples of the surface active agent include Triton X-100, sodium dodecylbenzene sulfonate (Na-DDBS), cetyl trimethyl ammonium bromide (CTAB) and sodium dodecyl sulfate (SDS). For another example, the conductive fiber aqueous dispersion solution is prepared by adding the conductive fiber to the aqueous solution and applying ultrasonic waves to the solution, for example, for 1 to 120 minutes.

However, the conductive fiber dispersion solution 140 may be prepared by other methods. For example, the conductive fiber dispersion solution 140 may be prepared by adding the conductive fiber 131 to an organic solvent, such as N-methylpyrrolidone (NMP), o-dichlorobenzene, dichloroethane, dimethylformamide (DMF) and chloroform.

Subsequently, the conductive fiber dispersion solution 140 stored in the solution container 150 is filtered by the vacuum filter 160. In this case, the initial base layer 210 is mounted on a part of the vacuum filter 160, which faces the solution container 150, and the conductive fiber dispersion solution 140 is provided on the initial base layer 210. A negative pressure is applied from the vacuum filter 160 to the initial base layer 210.

Accordingly, at least part of the materials except the conductive fiber 131 is removed through the pores 213 of the initial base layer 210, whereby the conductive fiber thin-film 130 is uniformly formed on the initial base layer 210. Subsequently, the conductive fiber thin-film 130 thus formed is cleaned with water. The conductive fiber thin-film may be prepared by other methods.

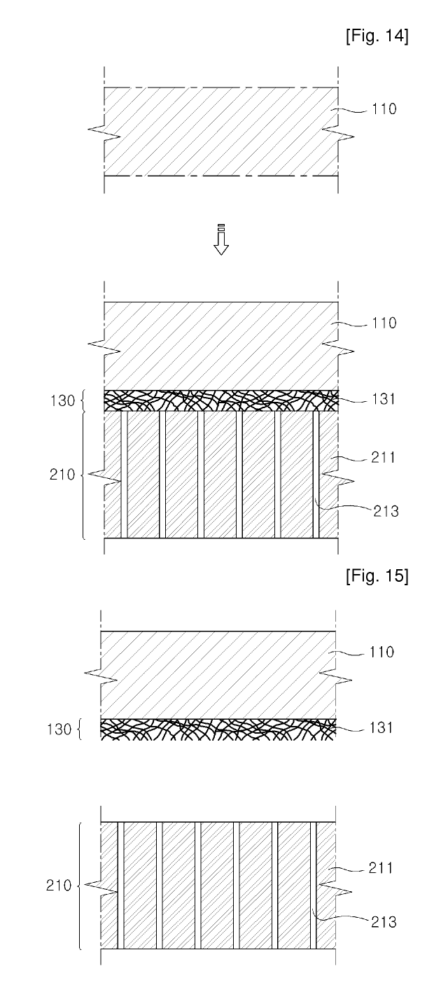

Subsequently, as shown in FIGS. 14 and 15, the conductive fiber thin-film 130 formed on the initial base layer 210 is moved to a final base layer 110. That is, the conductive fiber thin-film 130 is uniformly dispersed on the initial base layer 210 by vacuum filtering, and the conductive fiber thin-film 130 is moved to the final base layer 110, whereby the conductive composite material 100 is formed of the final base layer 110 and the conductive fiber thin-film 130 formed on the final base layer 110.

For example, after the conductive fiber thin-film 130 is uniformly dispersed on the initial base layer 210, the initial base layer 210 and the final base layer 110 are tightly joined and then separated with more than a predetermined level of heat applied or with a binding member provided on a portion in which a pattern of the final base layer 110 is to be formed. As a result, the conductive fiber having the pattern is formed on the final base layer 110. Accordingly, it is easy to form the pattern compared to the conventional method for manufacturing the conductive composite material in which the transparent conductive thin-film is formed on the substrate by coating, spraying, etc.

When an organic solvent is conventionally used to form the transparent conductive film on a substrate made of a polymer film, at least part of the substrate may melt due to the organic solvent. This may cause the evenness of the substrate to be deteriorated, resulting in a reduced conductivity. However, according to the present embodiment of the invention, the conductive composite material is prepared by moving the conductive fiber thin-film 130, which is placed on the initial base layer 210 using the organic solvent, to the final base layer 110 without contacting with the organic solvent, whereby the conductive composite material has an enhanced evenness and conductivity. After the conductive fiber thin-film 130 is moved, the initial base layer 210 can be reused to manufacture another conductive fiber thin-film.

In addition, the conductive fiber thin-film 130 is thin in thickness and has a high conductivity, whereby the conductive composite material has an enhanced transparency.

The final base layer 110 may be made of a transparent polymer, which increases the transparency of the conductive composite material. In this case, the final base layer 110 may be made of polyethylene terephtalate.

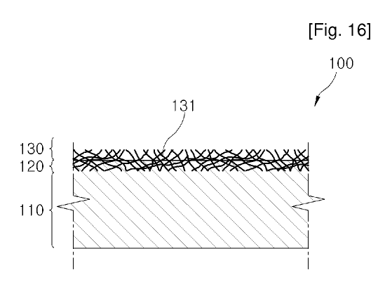

The final base layer 110 is made of a material which is lower in softening point than the first base layer 210. The step of moving the conductive fiber thin-film 130 to the final base layer 110 is performed, as shown in FIGS. 14 and 16, by pressing the final base layer 110 to the conductive fiber thin-film 130 and separating the first base layer 210 and the final base layer 110 from each other at a certain temperature between a softening point of the first base layer 210 and a softening point of the final base layer 110. That is, at a temperature higher than the softening point of the final base layer 110, the final base layer 110 is softened such that a different material tends to be inserted. However, since the temperature is lower than the softening point of the first base layer 210, the conductive fiber thin-film 130 is not fixed to the initial base layer 210 very securely. Accordingly, when the conductive fiber thin-film 130 placed on the initial base layer 210 is made contact with or pressed to the final base layer 110 at the temperature, the conductive fiber thin-film 130 is moved to the final base layer 110 with a high level of adhesion.

For another example, an additional adhesion layer having a higher level of adhesion than that of the initial base layer 210 to the conductive fiber thin-film 130 is formed on the surface of the final base layer 110, and the conductive fiber thin-film 130 placed on the initial base layer 210 is made contact with or pressed to the final base layer 110. For another example, the initial base layer having the conductive fiber thin-film formed thereon may be made contact with an additional final base layer having a higher surface energy than that of the initial base layer to move the conductive fiber thin-film.

In addition, the conductive fiber thin-film placed on the initial base layer is moved onto the final base layer by heat-transfer printing to obtain a patterned conductive fiber thin-film.

As shown in FIG. 16, the method according to the present embodiment of the invention may further include inserting at least part of the conductive fiber 131 of the conductive fiber thin-film 130 into at least part of the final base layer 110.

Accordingly, the conductive composite material 100 includes the final base layer 110, the conductive fiber thin-film 130 made only of the conductive fiber, and the mixture layer 120 having the final base layer impregnated with the conductive fiber. For example, after more than a predetermined level of heat (normally more than a softening point) is applied to the final base layer 110, the final base layer 110 and the conductive fiber thin-film 130 are pressed with a pressing unit, such as a roller. That is, when the final base layer 110 is softened at a predetermined high temperature, the final base layer 110 and the conductive fiber thin-film 130 are pressed with a pressing unit, whereby part of the conductive fiber 131 impregnates part of the final base layer 110. Next, when the conductive composite fiber 100 is cooled down during a predetermined time, the final base layer 110 is hardened with the part of the conductive fiber 131 inserted therein. Therefore, the conductive fiber thin-film 130 is securely fixed to the final base layer 110.

A method for manufacturing the conductive composite material will be described in detail.

A carbon nanotube was used as the conductive fiber 130, and a polyethersulfone membrane with pores 213 each having a diameter of 0.2 mm was used as the initial base layer 210.

The step of fixing the conductive fiber thin-film 130 to the initial base layer 210 was performed using the vacuum filter shown in FIG. 13. Referring to FIG. 13, 0.0015 wt % carbon nanotube aqueous dispersion solution 140 was prepared by adding 15 mg of a single-walled carbon nanotube 131 (mfg. by ILJIN Nanotech) to 11 of the aqueous solution 141 in which 10 g of SDS as a surface active agent was dissolved, and applying 40 kHz ultrasonic waves of 45 W for 30 minutes.

Next, 80 ml of the carbon nanotube aqueous dispersion solution 140 from the container 150 was filtered by the large-sized vacuum filter 160 with a filtering area of 500 cm².

In this case, the initial base layer 210 made of a polyethersulfone membrane with pores each having a diameter of 0.2 mm is provided in the large-sized vacuum filter 160. A solvent except the carbon nanotube was filtered through the pores 213, such that a carbon nanotube film was uniformly formed on the initial base layer 210. Next, the carbon nanotube film thus formed was cleaned with water.

Subsequently, a clean polyethylene terephtalate film was closely attached to the surface of the carbon nanotube thin-film formed of a composite material of the carbon nanotube/initial base layer, and then passed through the heat roller with a temperature of 80° C. After that, the initial base layer was mechanically peeled off and the carbon nanotube film was moved to the polyethylene terephtalate film, whereby the transparent conductive composite material was prepared.

The light transmissivity of the transparent conductive composite material thus manufactured was measured to be about 90% at 550 nm by an ultraviolet-visible spectroscope. The surface resistance of the transparent electrode was measured to be less than 200 Ω/sq by a surface resistance meter. In addition, the uniformity of surface resistance, i.e., the standard-deviation/average of surface resistance, was less than 7%.

The adhesion stability of the carbon nanotube film was estimated at 5B (indicating that there is no carbon nanotube to be removed) by the tape test (ASTM D 3359-02).

As described above, the transparent electrode manufactured according to the present embodiment of the invention was proved to be excellent in transparency, conductivity, uniformity of conductivity, flexibility, and adhesion stability of the carbon nanotube film.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention can effectively be applied to a conductive composite material, which is flexible and used in an electronic product such as a flat panel display, and a method for manufacturing the same.

1.-12. (canceled)

13. A method for manufacturing a conductive composite material, comprising:
providing a membrane;
forming a conductive fiber thin-film on the membrane by removing through the membrane at least part of materials except conductive fiber from the conductive fiber dispersion solution.

14. The method of claim 13, after forming a conductive fiver thin-film on the membrane, further comprising removing pores of the membrane by applying at least one of heat, pressure, light and voltage to the membrane.

15. (canceled)

16. The method of claim 13, after forming a conductive fiber thin-film on the membrane further comprising removing pores of the membrane, wherein the removing of the pores of the membrane comprises: coating a soluble organic solvent on at least the membrane; and drying the membrane.

17. (canceled)

18. (canceled)

19. The method of claim 13, wherein the membrane is a polymer membrane.

20. (canceled)

21. The method of claim 19, wherein the membrane has pores each having a diameter of 0.01 to 10 μm.

22. The method of claim 13, wherein forming a carbon nano-fiber film on the membrane is performed by vacuum filtering, self-assembly technique, Langmuir-Blodgett technique, solution casting, bar coating, dip coating, spin coating, or jet coating.

23. The method of claim 13, further comprising stacking a transparent polymer film on at least one side of the conductive composite material after forming the carbon nano-fiber film on the membrane.

24. The method of claim 13, wherein fixing the carbon nano-fiber film to the membrane comprises inserting at least part of a carbon nanotube forming the carbon nano-fiber film into at least part of the membrane.

25. The method of claim 24, wherein inserting at least part of a carbon nanotube is performed during making the membrane transparent.

26.-37. (canceled)

38. A method for manufacturing a conductive composite material, comprising:
providing an initial base layer;
providing a conductive fiber thin-film on the initial base layer; and
moving the conductive fiber thin-film provided on the initial base layer to a final base layer.

39. (canceled)

40. The method of claim 38, wherein the initial base layer is made of a membrane.

41. The method of claim 40, wherein providing a conductive fiber thin-film on the initial base layer comprises:
providing a conductive fiber dispersion solution on the initial base layer; and
removing through membrane pores of the initial base layer at least part of materials except conductive fiber from the conductive fiber dispersion solution.

42. The method of claim 41, wherein providing a conductive fiber thin-film on the initial base layer comprises:
positioning the initial base layer on a vacuum filter;
positioning the conductive fiber dispersion solution on the initial base layer; and
applying a negative pressure from the vacuum filter to the initial base layer.

43. (canceled)

44. (canceled)

45. The method of claim 38, wherein the final base layer is made of a transparent polymer.

46. (canceled)

47. The method of claim 38,
wherein the final base layer is made of a material lower in softening point than the initial base layer, and
wherein moving the conductive fiber thin-film to a final base layer is performed by closely attaching the final base layer to the conductive fiber thin-film and separating the final base layer and the initial base layer from each other at temperatures between a softening point of the initial base layer and a softening point of the final base layer.

48. The method of claim 38,
wherein the final base layer is made of a material higher in surface energy than the initial base layer, and
wherein moving the conductive fiber thin-film to a final base layer is performed by closely attaching the final base layer to the conductive fiber thin-film and separating the final base layer and the initial base layer from each other.

49. The method of claim 38, wherein moving the conductive fiber thin-film to a final base layer comprises making the conductive fiber thin-film patternized by heat-transfer printing.

50. The method of claim 38, further comprising inserting at least part of conductive fiber forming the conductive fiber thin-film into at least part of the final base layer after moving the conductive fiber thin-film to the final base layer.

51. The method of claim 50, wherein inserting at least part of a conductive fiber into at least part of the final base layer is performed by heat-pressing the final base layer and the conductive fiber.

52.-58. (canceled)
